(19) United States
(12) Patent Application Publication
(10) Pub. No.: US 2024/0028723 A1
(43) Pub. Date: Jan. 25, 2024

(54) SUSPICIOUS WORKSPACE INSTANTIATION DETECTION

(71) Applicant: Dell Products L.P., Round Rock, TX (US)

(72) Inventors: Girish S. Dhoble, Austin, TX (US); David Konetski, Austin, TX (US); Nicholas D. Grobelny, Evergreen, CO (US)

(21) Appl. No.: 17/870,523

(22) Filed: Jul. 21, 2022

(51) Int. Cl. G06F 21/56

(52) U.S. Cl. CPC G06F 21/566; G06F 21/568

(57) ABSTRACT

Workspace instantiations are monitored for potentially suspicious behavior. When a workspace is instantiated, a client endpoint computer creates a log of historical workspace instantiations. Each time the client endpoint computer requests, receives, or executes a workspace, the client endpoint computer adds and timestamps a new entry in the log of historical workspace instantiations. The log of historical workspace instantiations thus represents a rich database description of each workspace, its corresponding workspace definition file, and its corresponding timestamp. A workspace orchestration service may monitor how frequently the log of historical workspace instantiations is generated and flag or alert of unusual or anomalous counts. Any current workspace instantiation may thus be terminated as a security precaution.

### FIELD OF THE DISCLOSURE

This disclosure generally relates to information handling systems, and more particularly relates to detection of suspicious workspace activity.

### CROSS-REFERENCE TO RELATED APPLICATION

This patent application relates to U.S. patent application Ser. No. 16/670,658 filed Oct. 31, 2019, since published as U.S. Patent Application Publication 2021/0133298, and incorporated herein by reference in its entirety.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

Workspace instantiations are monitored for potentially suspicious behavior. When a workspace is instantiated, a client endpoint computer creates a log of historical workspace instantiations. Each time the client endpoint computer requests, receives, or executes a workspace, the client endpoint computer adds and timestamps a new entry in the log of historical workspace instantiations. The log of historical workspace instantiations thus represents a rich database description of each workspace, its corresponding workspace definition file, and its corresponding timestamp. A workspace orchestration service may monitor how frequently the log of historical workspace instantiations is generated and flag or alert of unusual or anomalous counts. Any current workspace instantiation may thus be terminated as a security precaution.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates an information handling system incorporating an intelligent imaging device, according to exemplary embodiments;

FIGS. 2-3 are simplified illustrations of detecting suspicious workspace instantiations, according to exemplary embodiments;

FIG. 4 illustrates behavioral isolation, according to exemplary embodiments;

FIG. 5 illustrates network logging and monitoring, according to exemplary embodiments;

FIG. 6 illustrates local analysis, according to exemplary embodiments; and

FIGS. 7-9 illustrate a method for providing a workspace orchestration service, according to exemplary embodiments.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings.

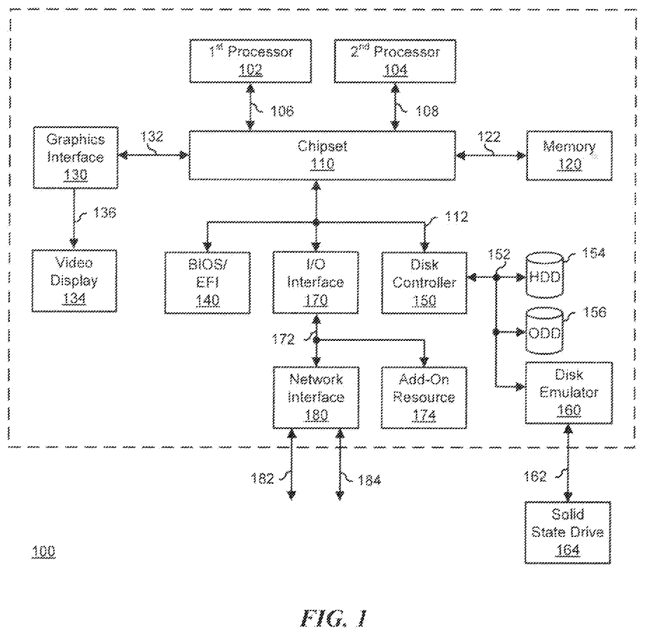

FIG. 1 illustrates an embodiment of an information handling system 100 including processors 102 and 104, chipset 110, memory 120, graphics adapter 130 connected to video display 134, non-volatile RAM (NV-RAM) 140 that includes a basic input and output system/extensible firmware interface (BIOS/EFI) module 142, disk controller 150, hard disk drive (HDD) 154, optical disk drive (ODD) 156, disk emulator 160 connected to solid state drive (SSD) 164, an input/output (I/O) interface 170 connected to an add-on resource 174, and a network interface device 180. Processor 102 is connected to chipset 110 via processor interface 106, and processor 104 is connected to chipset 110 via processor interface 108.

Chipset 110 represents an integrated circuit or group of integrated circuits that manages data flow between processors 102 and 104 and the other elements of information handling system 100. In a particular embodiment, chipset 110 represents a pair of integrated circuits, such as a north bridge component and a south bridge component. In another embodiment, some or all of the functions and features of chipset 110 are integrated with one or more of processors 102 and 104. Memory 120 is connected to chipset 110 via a memory interface 122. An example of memory interface 122 includes a Double Data Rate (DDR) memory channel, and memory 120 represents one or more DDR Dual In-Line Memory Modules (DIMMs). In a particular embodiment, memory interface 122 represents two or more DDR channels. In another embodiment, one or more of processors 102 and 104 include memory interface 122 that provides a dedicated memory for the processors. A DDR channel and the connected DDR DIMMs can be in accordance with a particular DDR standard, such as a DDR3 standard, a DDR4 standard, a DDR5 standard, or the like. Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like.

Graphics adapter 130 is connected to chipset 110 via a graphics interface 132, and provides a video display output 136 to a video display 134. An example of a graphics interface 132 includes a peripheral component interconnect-express interface (PCIe) and graphics adapter 130 can include a four lane (×4) PCIe adapter, an eight lane (×8) PCIe adapter, a 16-lane (×16) PCIe adapter, or another configuration, as needed or desired. In a particular embodiment, graphics adapter 130 is provided on a system printed circuit board (PCB). Video display output 136 can include a digital video interface (DVI), a high definition multimedia interface (HDMI), DisplayPort interface, or the like. Video display 134 can include a monitor, a smart television, an embedded display such as a laptop computer display, or the like.

NV-RAM 140, disk controller 150, and I/O interface 170 are connected to chipset 110 via I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller 150 to HDD 154, to ODD 156, and to disk emulator 160. Disk interface 152 may include an integrated drive electronics (IDE) interface, an advanced technology attachment (ATA) such as a parallel ATA (PATA) interface or a serial ATA (SATA) interface, a SCSI interface, a USB interface, a proprietary interface, or a combination thereof. Disk emulator 160 permits a solid-state drive (SSD) 164 to be connected to information handling system 100 via an external interface 162. An example of external interface 162 includes a USB interface, an IEEE 1394 (Firewire) interface, a proprietary interface, or a combination thereof. Alternatively, SSD 164 can be disposed within information handling system 100.

I/O interface 170 includes a peripheral interface 172 that connects I/O interface 170 to add-on resource 174, to TPM 176, and to network interface device 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a sound card, data storage system, an additional graphics interface, another add-on resource, or a combination thereof. Add-on resource 174 can be on a main circuit board, a separate circuit board or an add-in card disposed within information handling system 100, a device that is external to the information handling system, or a combination thereof.

Network interface device 180 represents a network communication device disposed within information handling system 100, on a main circuit board of the information handling system, integrated onto another element such as chipset 110, in another suitable location, or a combination thereof. Network interface device 180 includes a network channel 182 that provides an interface to devices that are external to information handling system 100. In a particular embodiment, network channel is of a different type than peripheral channel 172 and network interface device 180 translates information from a format suitable to the peripheral channel to a format suitable to external devices. In a particular embodiment, network interface device 180 includes a host bus adapter (HBA), a host channel adapter, a network interface card (NIC), or other hardware circuit that can connect the information handling system to a network. An example of network channel 182 includes an InfiniBand channel, a fiber channel, a gigabit Ethernet channel, a proprietary channel architecture, or a combination thereof. Network channel 182 can be connected to an external network resource (not illustrated). The network resource can include another information handling system, a data storage system, another network, a grid management system, another suitable resource, or a combination thereof.

The information handling system 100 may include a baseboard management controller (BMC). The BMC is connected to multiple elements of information handling system 100 via one or more management interface to provide out of band monitoring, maintenance, and control of the elements of the information handling system. As such, BMC represents a processing device different from processors 102 and 104, which provides various management functions for information handling system 100. In an embodiment, BMC may be responsible for granting access to a remote management system that may establish control of the elements to implement power management, cooling management, storage management, and the like. The BMC may also grant access to an external device. In this case, the BMC may include transceiver circuitry to establish wireless communications with the external device such as a mobile device.

The transceiver circuitry may operate on a Wi-Fi channel, a near-field communication (NFC) channel, a Bluetooth or Bluetooth-Low-Energy (BLE) channel, a cellular based interface such as a global system for mobile (GSM) interface, a code-division multiple access (CDMA) interface, a universal mobile telecommunications system (UMTS) interface, a long-term evolution (LTE) interface, another cellular based interface, or a combination thereof. A mobile device may include Ultrabook, a tablet computer, a netbook, a notebook computer, a laptop computer, mobile telephone, a cellular telephone, a smartphone, a personal digital assistant, a multimedia playback device, a digital music player, a digital video player, a navigational device, a digital camera, and the like.

The term BMC may be used in the context of server systems, while in a consumer-level device a BMC may be referred to as an embedded controller (EC). A BMC included at a data storage system can be referred to as a storage enclosure processor. A BMC included at a chassis of a blade server can be referred to as a chassis management controller, and embedded controllers included at the blades of the blade server can be referred to as blade management controllers. Out-of-band communication interfaces between BMC and elements of the information handling system may be provided by management interface that may include an inter-integrated circuit (I²C) bus, a system management bus (SMBUS), a power management bus (PMBUS), a low pin count (LPC) interface, a serial bus such as a universal serial bus (USB) or a serial peripheral interface (SPI), a network interface such as an Ethernet interface, a high-speed serial data link such as PCIe interface, a network controller-sideband interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

In an embodiment, the BMC implements an integrated remote access controller (iDRAC) that operates to monitor and maintain system firmware, such as code stored in BIOS/EFI module 142, option ROMs for graphics interface 130, disk controller 150, add-on resource 174, network interface 180, or other elements of information handling system 100, as needed or desired. In particular, BMC includes a network interface that can be connected to a remote management system to receive firmware updates, as needed or desired. Here BMC receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC utilizes various protocols and application programming interfaces (APIs) to direct and control the processes for monitoring and maintaining the system firmware. An example of a protocol or API for monitoring and maintaining the system firmware includes a graphical user interface (GUI) associated with BMC, an interface defined by the Distributed Management Taskforce (DMTF) (such as Web Services Management (WS-MAN) interface, a Management Component Transport Protocol (MCTP) or, Redfish interface), various vendor defined interfaces (such as Dell EMC Remote Access Controller Administrator (RACADM) utility, Dell EMC Open Manage Server Administrator (OMSS) utility, Dell EMC Open Manage Storage Services (OMSS) utility, Dell EMC Open Manage Deployment Toolkit (DTK) suite), representational state transfer (REST) web API, a BIOS setup utility such as invoked by a “F2” boot option, or another protocol or API, as needed or desired.

In a particular embodiment, BMC is included on a main circuit board (such as a baseboard, a motherboard, or any combination thereof) of information handling system 100, or is integrated into another element of the information handling system such as chipset 110, or another suitable element, as needed or desired. As such, BMC can be part of an integrated circuit or a chip set within information handling system 100. BMC may operate on a separate power plane from other resources in information handling system 100. Thus BMC can communicate with the remote management system via network interface or the BMC can communicate with the external mobile device using its own transceiver circuitry while the resources or elements of information handling system 100 are powered off or at least in low power mode. Here, information can be sent from the remote management system or external mobile device to BMC and the information can be stored in a RAM or NV-RAM associated with the BMC. Information stored in the RAM may be lost after power-down of the power plane for BMC, while information stored in the NV-RAM may be saved through a power-down/power-up cycle of the power plane for the BMC.

Because the information handling system 100 may operate in an enterprise networking environment, security threats are a concern. A data center, for example, may have hundreds or even thousands of different information handling systems, such as servers, switches, routers, and data storage equipment. All these information handling systems process vast amounts of sensitive/proprietary electronic data. Conventional data security schemes would merely isolate an entire network to prevent security threats. However computer users increasingly need data access from home, coffee shops, hotels, and other remote locations. Today's users, in other words, must access electronic data using public and untrusted networks. Moreover, today's users may also access electronic data using many different enterprise machines, many different personal devices, and many different software applications. Simply put, electronic data must be protected, even though accessed by a great variety of machines, software, and networks.

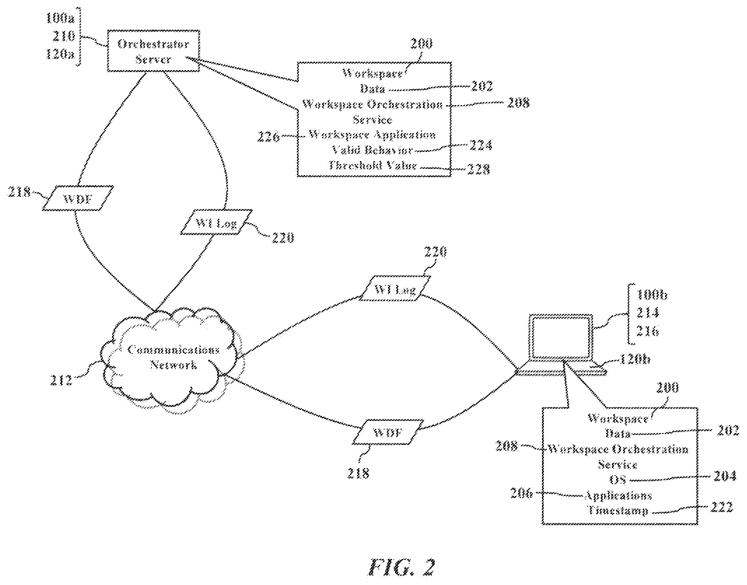

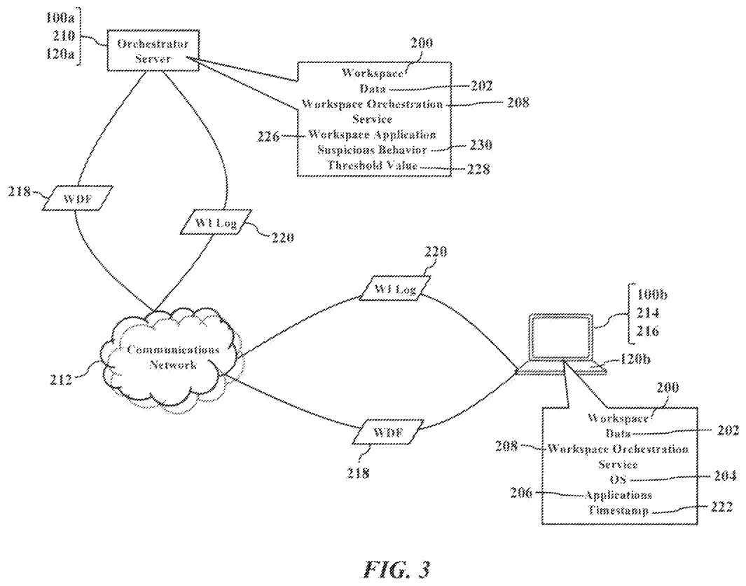

FIGS. 2-3 are simplified illustrations of detecting suspicious workspace instantiations, according to exemplary embodiments. One or more of the information handling systems 100 may be configured for securing a dynamic workspace 200 in an enterprise productivity ecosystem. The information handling systems 100 cooperate to instantiate, manage, and/or terminate the workspace 200. The workspace 200 is a digital or virtual secure environment that provides access to sensitive/proprietary/enterprise electronic data 202. The workspace 200, however, also isolates the sensitive/proprietary/enterprise electronic data 202 from an operating system (illustrated as “OS”) 204 and other software applications 206.

FIG. 2 thus illustrates a workspace orchestration service 208. An orchestrator server 210 communicates via a communications network 212 with an endpoint computer 214. The orchestrator server 210 is a server-version of the information handling system (illustrated as reference numeral 100a). The endpoint computer 214 is illustrated as a mobile or laptop computer 216, which most readers understand as another version of the information handling system (illustrated as reference numeral 100b). The orchestrator server 210 provides the workspace orchestration service 208 to the endpoint computer 214. That is, the orchestrator server 210 and the endpoint computer 214 cooperate, perhaps in a client/server relationship, to initialize the dynamic workspace 200, to orchestrate the dynamic workspace 200, and to terminate the dynamic workspace 200.

The dynamic workspace 200 is defined according to a workspace definition file (illustrated as “WDF”) 218. The workspace definition file 218 is generated by the orchestrator server 210 providing the workspace orchestration service 208. The orchestrator server 210 sends the workspace definition file 218 via the communications network 212 to the endpoint computer 214. When the endpoint computer 214 receives the workspace definition file 218, the endpoint computer 214 cooperates with the orchestrator server 210 to orchestrate the dynamic workspace 200, as specified by the workspace definition file 218. There are many complicated concepts, components, and factors that are related to the workspace orchestration service 208, which this disclosure will later explain.

The workspace 200 may be compromised. The inventors have noticed that the workspace 200 may be repeatedly instantiated with unusual or abnormal frequency. For example, when the workspace definition file 218 is corrupted, the workspace 200 may be repeatedly instantiated. Even more concerning is that repeated instantiations may indicate a security attack (such as a Denial of Service attack to keep the workspace 200 offline, or repeated attempts to attack the workspace 200). These frequent instantiations might result in the workspace 200 being re-created/reset often in a period of time in order to maintain target metrics (such as a productivity score and security score).

Exemplary embodiments detect and remediate such workspace instantiation behavior in an automated and timely manner. As FIG. 2 illustrates, the endpoint computer 214 generates and maintains a workspace instantiation log (illustrated as “WI Log”) 220. The workspace instantiation log 220 is stored in the memory device (illustrated as 120b) of the endpoint computer 214. The workspace instantiation log 220 represents a historical record of workspace instantiations attempted, and/or requested, by the endpoint computer 214. That is, each time the endpoint computer 214 attempts or requests to instantiate the workspace 200 (for example identified by the workspace definition file 218), the endpoint computer 214 alerts or notifies the orchestrator server 210. The endpoint computer 214, for example, may send the workspace instantiation log 220 to the orchestrator server 210 to document any attempt or request to instantiate the workspace 200. The workspace instantiation log 220 may contain a single entry describing a current instantiation. The orchestrator server 210 may then maintain a comprehensive, historical log or count of the historical instantiations performed or attempted by the endpoint computer 214. The endpoint computer 214, however, may optionally generate the workspace instantiation log 220 as many entries describing historical instantiations of the workspace 200.

As another example, an entry may be added to the workspace instantiation log 220 each time the workspace definition file 218 is executed by the endpoint computer 214. However the workspace 200 and/or the workspace definition file 218 are logged, the endpoint computer 214 may also determine and log an instantiation timestamp 222. The workspace instantiation log 220 thus has entries that map or relate the workspace 200 (such as the workspace definition file 218) to the instantiation timestamps 222 marking each instantiation request, receipt, and/or execution. As the endpoint computer 214 may initiate many different workspaces 200 (and their corresponding workspace definition files 218), the workspace instantiation log 220 logs a rich database repository of each workspace 200, the corresponding workspace definition file 218 (such as a unique filename or other identifier) and its corresponding instantiation timestamp 222.

The workspace instantiation log 220 may thus identify valid behavior 224. Each time the workspace 200 is instantiated, exemplary embodiments may inspect the workspace instantiation log 220 and determine the number of times that the current or same workspace definition file 218 has historically been previously instantiated. The endpoint computer 214, for example, may send the entire workspace instantiation log 220, or any portion or part of its entries, to the IP address associated with the orchestrator server 210. When the orchestrator server 210 receives the entries representing some or all of the workspace instantiation log 220, the orchestrator server 210 may inspect the entries for the valid behavior 224. The orchestrator server 210 may store a workspace software application 226 in its memory device (illustrated as 120a).

When the orchestrator server 210 executes the workspace software application 226, the workspace software application 226 includes programming statements or instructions that cause the orchestrator server 210 to perform operations, such as summing or counting the current and/or historical instantiation entries or timestamps 222 associated with the workspace 200 and/or the workspace definition file 218. The orchestrator server 210 may query the workspace instantiation log 220 for a query parameter (such as the workspace definition filename) and identify/retrieve the corresponding entries. The sum or count of the logged instantiation events/entries may then be compared to a threshold value 228. The threshold value 228 represents an unusual or abnormal frequency of workspace instantiation events (such as an amount of the instantiation entries or timestamps 222 logged by the workspace instantiation log 220). If the sum or count of the instantiation events/entries is less than the threshold value 228, then perhaps the current workspace instantiation (requested by the endpoint computer 214) is inferred to be the valid behavior 224 and is permitted to proceed with orchestration.

FIG. 3, though, illustrates suspicious behavior 230, according to exemplary embodiments. The workspace software application 226 instructs or causes the orchestrator server 210 to compare the instantiation of the workspace 200 to the threshold value 228. The orchestrator server 210, in other words, may assume the burden of detecting the suspicious behavior 230. The orchestrator server 210, for example, may count the number of times the endpoint computer 214 has executed the same workspace definition file 218 (as identified by the workspace instantiation log 220) within a predefined period of time (such as 60 minutes, a single day, or other measure). The threshold value 228 may be defined as a logical rule expressing a maximum number of instantiation generations, receipts, executions, and/or re-instantiations of the workspace definition file 218 (as identified by the workspace instantiation log 220) within a predefined period of time (as revealed by the workspace instantiation log 220).

The orchestrator server 210 may query the workspace instantiation log 220 for any query parameter (such as the workspace definition filename) and identify/retrieve the corresponding instantiation events/timestamps 222. The sum or count of the instantiation events/timestamps 222 may then be compared to the threshold value 228. When the sum or count of the instantiation attempts/timestamps 222 is equal to or greater than the threshold value 228, then the current workspace instantiation is inferred to be the suspicious behavior 230. The current workspace instantiation file 218, for example, may not be permitted to proceed to orchestration. The orchestrator server 210, in other words, may halt or terminate the instantiation and/or orchestration of the current workspace 200 and/or its corresponding workspace instantiation file 218. The orchestrator server 210 may decline to send the workspace instantiation file 218 to the endpoint computer 214, if not already sent. The orchestrator server 210 may terminate workspace orchestration service 208.

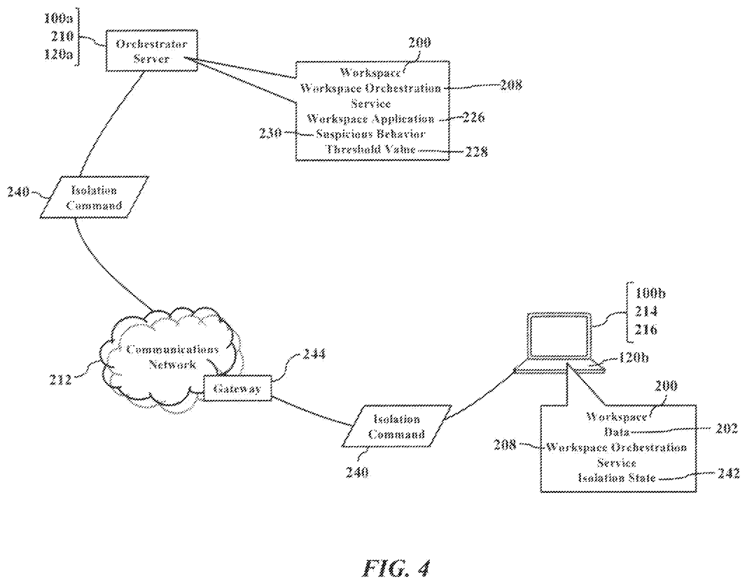

FIG. 4 illustrates behavioral isolation, according to exemplary embodiments. When the tally of the current and/or historical instantiations of the workspace 200 equal or even exceed the threshold value 228, the workspace software application 226 instructs or causes the orchestrator server 210 to infer the suspicious behavior 230. In response to the suspicious behavior 230, the orchestrator server 210 may also isolate the endpoint computer 214, as a further security precaution. The workspace software application 226, for example, may instruct or cause the orchestrator server 210 to send one or more isolation commands 240. The isolation commands 240 communicatively sever the endpoint computer 214 from the communications network 212. The isolation command 240, for example, may be sent to the IP address associated with the endpoint computer 214. The isolation command 240 causes the endpoint computer 214 to enter an isolation state 242 that disables any or all of the network interfaces 180 (illustrated in FIG. 1). The isolation command 240 may additionally or alternatively be sent to the IP address associated with a switch/modem/gateway 244 that interfaces between the endpoint computer 214 and the communications network 212. The isolation command 240 instructs or causes the switch/modem/gateway 244 to disable or shutdown a port serving, or assigned to, or associated with the endpoint computer 214. Now that the endpoint computer 214 is isolated, further root-causing and analysis may be safely performed.

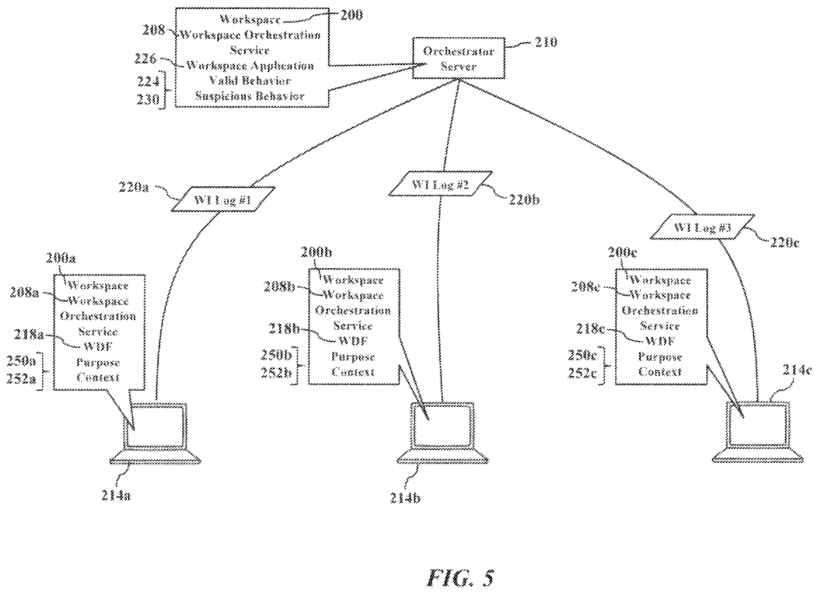

FIG. 5 illustrates network logging and monitoring, according to exemplary embodiments. Here the orchestrator server 210 may monitor multiple workspace instantiation logs 220 sent by many endpoint computers 214. There may be many human users using many different endpoint computers 214, especially in an enterprise networking environment. The users have different workspaces 200, depending on their individual purpose 250 and context 252. While there may be hundreds of different users and their respective endpoint computers 214 in an enterprise networking environment, so many endpoint computers 214 are too difficult to illustrate. FIG. 5 thus simply illustrates three (3) endpoint computers 214a-c. Each endpoint computer 214a-c cooperates with the orchestrator server 210 to determine its corresponding dynamic workspace 200a-c and workspace definition file 218a-c, perhaps based on its corresponding purpose 250a-c and context 252a-c. Each endpoint computer 214a-c generates and stores its corresponding workspace instantiation log 220a-c. Each endpoint computer 214a-c sends its respective workspace instantiation log 220a-c to the orchestrator server 210. The orchestrator server 210 may inspect each workspace instantiation log 220a-c to identify the valid behavior 224 and/or the suspicious behavior 230.

Exemplary embodiments thus present an elegant computer security solution. Exemplary embodiments add an entry to the workspace instantiation logs 220a-c each time the corresponding endpoint computer 214a-c instantiates any dynamic workspace 200a-c (such as requesting, receiving, and/or executing the corresponding workspace definition file 218a-c). Each endpoint computer 214a-c may forward its corresponding workspace instantiation log 220a-c to describe the date/time and workspace definition file 218a-c currently or previously instantiated. The orchestrator server 210 may thus maintain a remotely-located, electronic backup copy of each workspace instantiation log 220a-c sent by the endpoint computers 214a-c. The orchestrator server 210 may even merge the entries representing the workspace instantiation logs 220a-c to obtain a global network view of how many times any single workspace 200, and/or its corresponding workspace definition file 218, is/are instantiated by any group or even all of the endpoint computers 214a-c.

For example, for a workspace definition file (such as “filename X”), the remote orchestrator server 210 maintains the workspace instantiation logs 220a-n from endpoints E₁, E₂, . . . E_{N} in its local memory 120a (such as a database). With this data (such as a log of logs), the remote orchestrator server 210 knows/estimates the usual number of log files that are generated at each endpoint computer 214 when the corresponding workspace 200 is instantiated. If a workspace 200 is corrupt or under attack, the workspace instantiation may fail. However, if the workspace instantiation succeeds, the workspace 200 may still reset/regenerate often in a period of time to maintain the productivity score (to keep the user productive). This would result in creation of large number of passing (or clean, good) logs at the endpoint computer 214. The orchestrator server 210 could consider such a number of passing entries (for example equaling or exceeding the threshold value 228) as either an indicator of attack or workspace corruption. Further remedial action, in other words, may be required, such as automated mitigation by isolation (as explained with reference to FIG. 4) and performing further analysis for root cause of the suspicious instantiation behavior.

Exemplary embodiments thus improve computer functioning. Exemplary embodiments detect any security attacks when all other indicators of attack fail to detect anomalous workspace instantiation behavior. Exemplary embodiments detect a compromised or corrupt workspace instance based on the unusual frequency of passing log generation during the instantiation phases of the workspace lifecycle. Workspace orchestration has the unique ability to maintain metadata to track and establish patterns across multiple iterations of passing workspace instantiation logs, which non-orchestrated workspaces cannot accomplish alone.

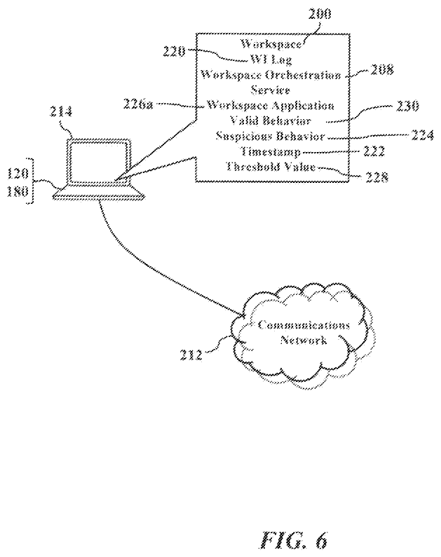

FIG. 6 illustrates local analysis, according to exemplary embodiments. Here the endpoint computer 214 may undertake the burden of detecting the suspicious behavior 230. That is, as the endpoint computer 214 builds the workspace instantiation log 220, the endpoint computer 214 may additionally or alternatively self-inspect the entries for the suspicious behavior 230. The endpoint computer 214 may store a client-side version of the workspace software application 226a in its memory device 120. When the endpoint computer 214 executes the client-side version of the workspace software application 226a, the client-side version of the workspace software application 226a includes programming statements or instructions that cause the endpoint computer 214 to perform operations, such as comparing the entries in the workspace instantiation log 220 to the threshold value 228 (as this disclosure above explains). The endpoint computer 214 may thus inspect the workspace instantiation log 220 to identify its own valid behavior 224 and to proceed with the current workspace instantiation and/or orchestration. Should, however, the endpoint computer 214 discover suspicious behavior 230 (based on the workspace instantiation log 220), then the endpoint computer 214 may self-impose security precautions (such as halting/terminating the instantiation and/or orchestration of the current workspace 200 and/or severing from the communications network 212 by disabling any or all of the network interfaces 180).

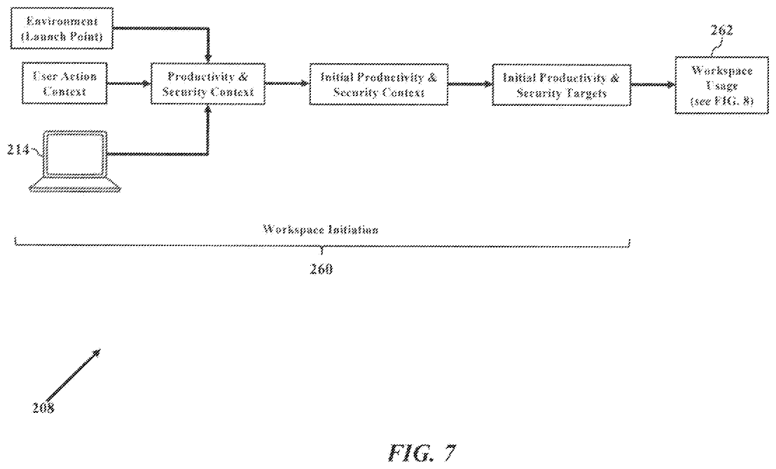

FIGS. 7-9 illustrate a method or algorithm providing the workspace orchestration service 208, according to exemplary embodiments. The workspace orchestration service 208 has three (3) basic phases that secure (instantiate, orchestrate, and terminate) the dynamic workspace 200 in an enterprise productivity ecosystem. FIGS. 7-9, though, only illustrate basic details, features, and concepts of the workspace orchestration service 208. The workspace orchestration service 208 is more thoroughly explained by U.S. patent application Ser. No. 16/670,658 filed Oct. 31, 2019, since published as U.S. Patent Application Publication 2021/0133298, and incorporated herein by reference in its entirety.

FIG. 7, for example, illustrates the workspace initialization phase 260. During the workspace initialization phase 260, a user operates the endpoint computer 214 within any physical environment (such as any type of environment and its associated context, including physical location, geographic location, location within a particular facility or building, detected networks, time of day, proximity of the user, individuals in the vicinity of the endpoint computer 214). An input action by the user is received via a launch point (such as accessing a web portal, a portal application, or a workspace). The launch point provides visibility to any resource (such as the electronic data 202 and software applications 206, illustrated in FIGS. 2-3). The workspace software application 226 and the client-side workspace software application 226a (as explained with reference to FIGS. 2-6) cooperate to provide access to the managed resources via the workspace orchestration service 208. In response to the user's input action or request, the client-side workspace software application 226a instructs or causes the endpoint computer 214 to collect initial security and productivity context information. The security context information may include attributes indicating a security risk associated with: the data and/or application being requested, a level of risk presented by the user, the hardware utilized by the endpoint computer 214, the logical environment of endpoint computer 214 in which the workspace 200 will be deployed to provide access to the requested data and/or application, and the physical environment in which the endpoint computer 214 is currently located.

The security context may be an abstract name or score representing the measurement of some security posture of the workspace 200. The security risk may be a score or index for measuring this context. The productivity context may be an abstract name, score, or measurement of real-time productivity of the workspace 200. The productivity score is an index for measuring the productivity context. The security target may be an abstract name, score, or measurement for the attack surface of the workspace definition. The productivity target may be an abstract name, score, or measurement for the productivity characteristics of the workspace definition. The initial productivity and security targets for the workspace 200 may be calculated based on the purpose 250 of the user's actions, perhaps combined with the productivity and security context 252 in which the workspace will operate. The productivity and security targets may also be based on behavioral analytics, telemetry and/or environmental information (collected via sensors).

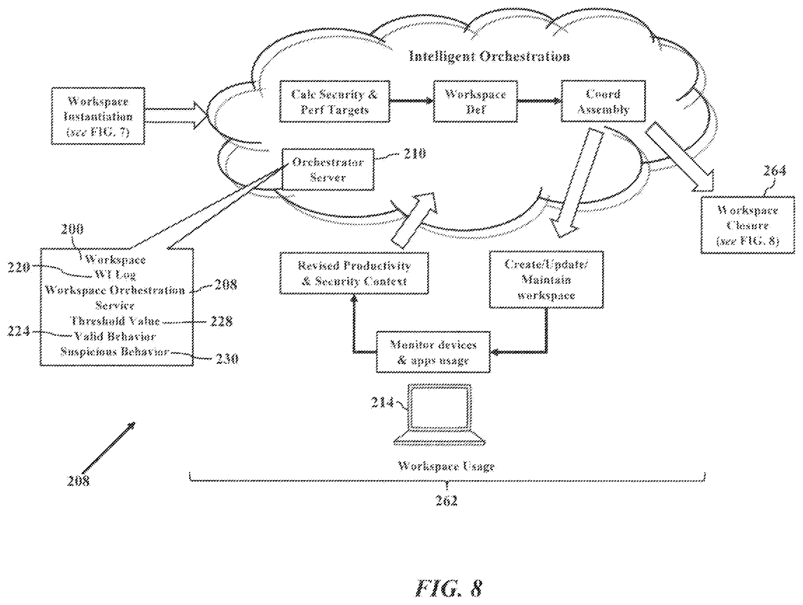

FIG. 8 illustrates the workspace orchestration phase 262. When the workspace initialization phase 260 completes, the workspace orchestration service 208 may enter or initiate the workspace orchestration phase 262. Exemplary embodiments may calculate security and productivity targets, perhaps based upon the collected security and productivity context. In other cases, remote workspace orchestration service 208 may calculate security and productivity targets. The workspace orchestration service 208 generates the workspace definition (perhaps represented by the WDF 218 illustrated in FIGS. 2-3). The workspace definition generally refers to a collection of attributes that describe aspects of the workspace 200 that may be assembled, created, and deployed in a manner that satisfies a security target and a productivity target, perhaps in light of the security context and the productivity context in which the workspace 200 is to be deployed. The workspace definition may enable fluidity of migration of the instantiated workspace 200, since the workspace definition file 218 may support the ability for the workspace 200 to be assembled and configured for operation with the workspace orchestration service 208. The workspace orchestration service 208 coordinates an assembly of the workspace 200 and sends/provides the workspace 200 to the endpoint computer 214.

Exemplary embodiments may monitor usage within the workspace 200. As the user interacts with the endpoint computer 214 within the workspace 200, exemplary embodiments may monitor the workspace 200 and usage (inputs, selections, configurations) and re-evaluate the productivity and security contexts. Any revisions to the productivity and security contexts may be received by the workspace orchestration service 208 as feedback inputs that may revise/modify the workspace definition. This feedback workspace loop may continue until the user's input indicates a termination or end of the workspace 200.

The workspace orchestration phase 262 may further monitor and count re-instantiations. As FIG. 8 illustrates, the orchestration server 210 may receive the workspace instantiation log 220 and inspect/analyze its entries. The orchestration server 210 compares the entries in the workspace instantiation log 220 to the threshold value 228 (as this disclosure above explains). The orchestration server 210 may thus inspect the workspace instantiation log 220 to identify the valid behavior 224 and to proceed with the current workspace instantiation and/or orchestration. Should, however, the orchestration server 210 discover the suspicious behavior 230 (based on the workspace instantiation log 220), then the orchestration server 210 may impose security precautions (such as nearly immediately entering, or proceeding to, the workspace termination phase 264 and/or communicatively severing the endpoint computer 214).

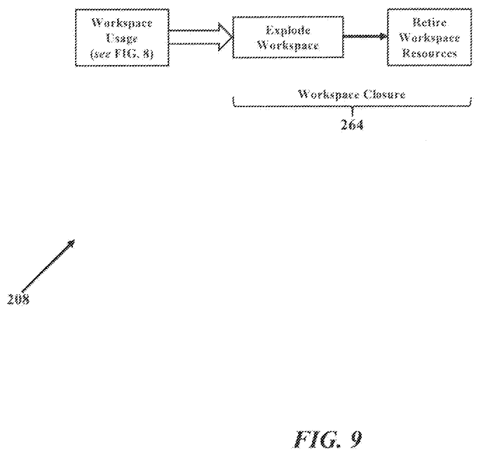

FIG. 9 illustrates the workspace termination phase 264. As the user interacts with the endpoint computer 214 within the workspace 200, exemplary embodiments may monitor the workspace 200 and usage (inputs, selections, configurations) and receive or infer an input to close or terminate the workspace 200. The user, for example, may close a software application or web browser. The workspace termination phase 264 may be automatically entered in response to the suspicious behavior 230 (and perhaps the isolation command 240 and/or isolation state 242, as explained with reference to FIG. 4). The workspace termination phase 264 breaks down and retires the resources representing the workspace 200. The resources are this made available for other tasks.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a laptop computer, a smart phone, a tablet device or other consumer electronic device, a network server, a network storage device, a switch router or other network communication device, or any other suitable device and may vary in size, shape, performance, functionality, and price. Further, an information handling system can include processing resources for executing machine-executable code, such as a central processing unit (CPU), a programmable logic array (PLA), an embedded device such as a System-on-a-Chip (SoC), or other control logic hardware. An information handling system can also include one or more computer-readable medium for storing machine-executable code, such as software or data. Additional components of information handling system can include one or more storage devices that can store machine-executable code, one or more communications ports for communicating with external devices, and various input and output (I/O) devices, such as a keyboard, a mouse, and a video display. An information handling system can also include one or more buses operable to transmit information between the various hardware components.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of detecting suspicious computer behavior, the method comprising:
generating, by an information handling system, a workspace associated with a client endpoint computer;
receiving a workspace instantiation log from the client endpoint computer, the workspace instantiation log describing the generating of the workspace associated with the client endpoint computer;
comparing the workspace instantiation log to a normal frequency of workspace instantiations;
inferring suspicious computer behavior based on the workspace instantiation log failing to match the normal frequency of the workspace instantiations; and
in response to the inferring of the suspicious computer behavior, terminating a current workspace instantiation associated with the workspace.

2. The method of claim 1, further comprising communicatively isolating the client endpoint computer.

3. The method of claim 1, further comprising sending an isolation command to the client endpoint computer.

4. The method of claim 1, further comprising inferring a valid computer behavior based on the workspace instantiation log.

5. The method of claim 4, wherein in response to the inferring of the valid computer behavior, further comprising orchestrating the current workspace instantiation.

6. The method of claim 1, further comprising generating a workspace definition file associated with the current workspace instantiation.

7. The method of claim 6, further comprising sending the workspace definition file to the client endpoint computer.

8. An information handling system, comprising:
a hardware processor; and
a memory device storing instructions that when executed by the hardware processor perform operations, the operations including:
sending a workspace definition file to a client endpoint computer;
receiving a workspace instantiation log from the client endpoint computer, the workspace instantiation log describing a current instantiation associated with the workspace definition file;
determining an instantiation count of historical workspace instantiations associated with the workspace definition file;
comparing the instantiation count of the historical workspace instantiations associated with the workspace definition file to a threshold value;
in response to the instantiation count of the historical workspace instantiations associated with the workspace definition file at least equaling the threshold value, terminating the current workspace instantiation associated with the workspace definition file.

9. The information handling system of claim 8, wherein the operations further include communicatively isolating the client endpoint computer.

10. The information handling system of claim 8, wherein the operations further include sending an isolation command to the client endpoint computer.

11. The information handling system of claim 8, wherein the operations further include inferring a valid computer behavior based on the workspace instantiation log.

12. The information handling system of claim 11, wherein in response to the inferring of the valid computer behavior, the operations further include orchestrating the current workspace instantiation.

13. The information handling system of claim 8, wherein the operations further include generating the workspace definition file associated with the current workspace instantiation.

14. A memory device storing instructions that when executed perform operations, the operations including:
generating a workspace definition file associated with a workspace orchestrated by a workspace orchestration service;
sending the workspace definition file to a client endpoint computer;
receiving a workspace instantiation log from the client endpoint computer, the workspace instantiation log describing historical workspace instantiations associated with the workspace definition file;
determining, from the workspace instantiation log, an instantiation count of the historical workspace instantiations associated with the workspace definition file;
if the instantiation count of the historical workspace instantiations associated with the workspace definition file exceeds the threshold value, then terminating the workspace orchestrated by a workspace orchestration service.

15. The memory device of claim 14, wherein the operations further include communicatively isolating the client endpoint computer.

16. The memory device of claim 14, wherein the operations further include sending an isolation command to the client endpoint computer.

17. The memory device of claim 14, wherein the operations further include determining the instantiation count of the historical workspace instantiations associated with the workspace definition file is less than the threshold value.

18. The memory device of claim 17, wherein in response to the instantiation count of the historical workspace instantiations associated with the workspace definition file being less than the threshold value, inferring a valid computer behavior.
